(19) United States
(12) Patent Application Publication
(10) Pub. No.: US 2014/0321791 A1
(43) Pub. Date: Oct. 30, 2014

(54) ELECTRO-OPTIC MODULATOR HAVING HIGH EXTINCTION RATIO WHEN FUNCTIONING AS SWITCH

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/945,915

(22) Filed: Jul. 19, 2013

(30) Foreign Application Priority Data
Apr. 30, 2013 (TW) 102115353

(51) Int. Cl. G02F 1/225

(52) U.S. Cl. CPC G02F 1/2257
USPC 385/3

(57) ABSTRACT

An electro-optic modulator includes a substrate, a Y-shaped waveguide, and electrodes. The waveguide is formed in the substrate with diverging and reconverging portions. The electrodes are formed in the substrate to sandwich the diverged portions of the waveguide and receive voltages which modulate each branch of the Y shaped waveguide such that power outputs of branches of the Y shape are precisely synchronized and an improved extinction ratio thus obtained.

### BACKGROUND

1. Technical Field

The present disclosure relates to integrated optics and, particularly to an electro-optic modulator having a high extinction ratio when functioning as a switch.

2. Description of Related Art

Electro-optic modulators, such as Mach-Zehner electro-optic modulators, change a refractive index of a branch of a Y-shaped waveguide (hereinafter the first branch) using a modulating electric field, utilizing electro-optic effect. Thus, the modulator can alter a phase of lightwaves traversing the first branch. As a result, the phase of lightwaves traversing the first branch can be shifted and thus interfere with lightwaves traversing another branch of the Y-shaped waveguide (hereinafter the second branch). An output of the Y-shaped waveguide is modulated as the power output depends on the phase shift, which in turn depends on the modulating electric field. However, being limited by manufacturing imprecision, the properties of the lightwaves respectively traversing the first and second branches are not equal to each other. As such, when the modulator is used as a switch, the power output is often larger than zero in an off state (i.e., the phase shift is π) or less than a desired maximum value in an on state (i.e., the phase shift is zero). An extinction ratio of the switch is less than satisfactory.

Therefore, it is desirable to provide an electro-optic modulator that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of an electro-optic modulator, according to an embodiment.

FIG. 2 is a cross-sectional view taken along a line II-II of FIG. 1.

### DETAILED DESCRIPTION

Embodiments of the present disclosure will be described with reference to the drawings.

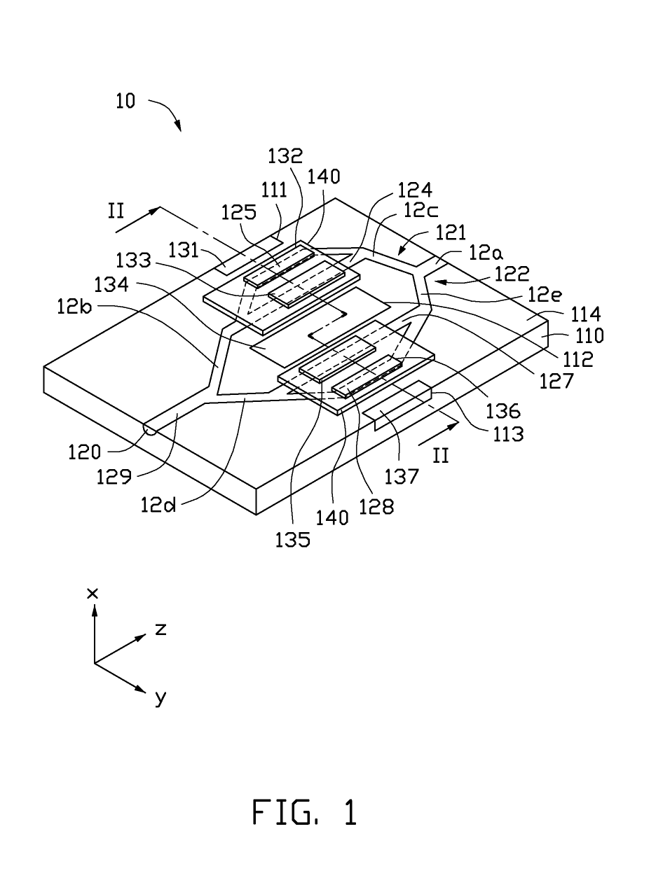

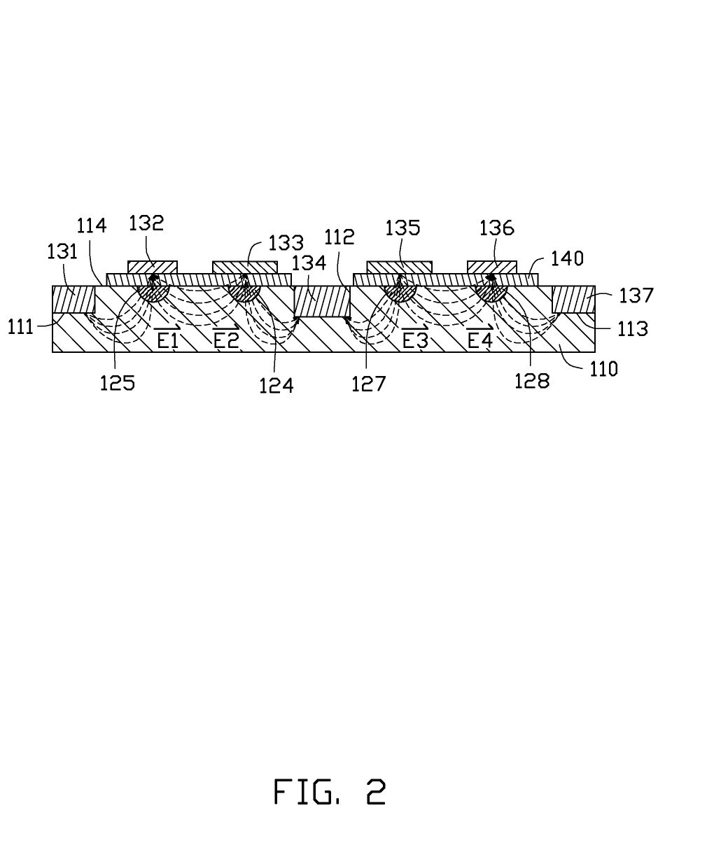

FIGS. 1 and 2 show an electro-optic modulator 10, according to an embodiment. The modulator 10 includes a substrate 110, a waveguide 120, a first modulating electrode 131, a first ground electrode 132, a second modulating electrode 133, a second ground electrode 134, a third modulating electrode 135, a third ground electrode 136, and a fourth modulating electrode 137.

The substrate 110 is made of lithium niobate (LiNbO₃) crystal to increase a bandwidth of the modulator 10, as LiNbO₃ crystal has a high response speed. In this embodiment, the substrate 110 is substantially rectangular and includes a top surface 114.

The waveguide 120 is formed by applying a layer of titanium as a coating on a substrate shaped to correspond to the waveguide 120 and diffusing the titanium into the substrate 110 by, for example, a high temperature diffusion technology. In this embodiment, the waveguide 120 is formed in the top surface 114.

The waveguide 120 is Y-shaped and formed in the substrate 110. The waveguide 120 includes a first section 121 and a second section 122. The first section 121 is Y-shaped and includes a first branch 124 and a second branch 125. The second section 122 is also Y-shaped and includes a third branch 127 and a fourth branch 128.

The first to fourth branches 124, 125, 127, 128 are substantially parallel with each other and the second and fourth branches 125, 128 are located at two opposite sides of the first and third branches 125, 127.

In addition to the first section 121 and the second section 122, the waveguide 120 includes an input section 129 and an output section 12a. The first and second sections 121, 122 diverge from the input section 129 and are converged into the output section 12a.

In addition to the first branch 124 and the second branch 125, the first section 121 includes a first input branch 12b and a first output branch 12c. The first and second branches 124 125 diverge from the first input branch 12b and are converged into the first output branch 12c.

In addition to the third branch 127 and the fourth branch 128, the second section 122 includes a second input branch 12d and a second output branch 12e. The third and fourth branches 127, 128 diverge from the second input branch 12d and are converged into the second output branch 12e.

The substrate 110 defines first to third recesses 111-113, all of which are rectangular and parallel with the first to fourth branches 124, 125, 127, 128. A depth of the first to third recesses 111-113 is greater than a thickness of the waveguide 120. The first and second recesses 111, 112 are located at two opposite sides of the first section 121. The second and third recesses 112, 113 are located at two opposite sides of the second section 122. The first recess 111 is the same length as, and is aligned with, the second branch 125. The third recess 113 is the same length as, and is aligned with, the fourth branch 128. Orthogonal projections of the first and third recesses 111, 113 on the second recess 112 fall within the second recess 112.

The first to third recesses 111-113 are completely infilled by the first modulating electrode 131, the second ground electrode 134, and the fourth modulating electrode 137, respectively.

The first ground electrode 132, the second modulating electrode 133, the third modulating electrode 135, and the third ground electrode 136 are strip-shaped and parallel with the first to fourth branches 124, 125, 127, 128. The first ground electrode 132, the second modulating electrode 133, the third modulating electrode 135, and the third ground electrode 136 are positioned on the top surface 114, and respectively cover the first to fourth branches 124, 125, 127, 128. The first ground electrode 132 and the second modulating electrode 133 have the same length as, and are aligned with, the second branch 125. The third modulating electrode 135 and the third ground electrode 136 have the same length as, and are aligned with, the fourth branch 128.

The first and second electrodes 130, 140 receive voltages applied thereto and accordingly modulate the refractive indices of the first and second sections 121, 122 such that the power outputs of the first and second sections 121, 122 are equal to each other.

In principle, the power output of the output section 12a can be calculated by the following equation:

αe^{i(α-wt)}=α₁e^{i(φ-wt)}+α₂e^{i(β-wt)},

wherein, α, α₁, α₂ are amplitudes of lightwaves traversing the output section 12a, the first output branch 12c, and the second output branch 12e respectively, α, φ, β are phases of lightwaves traversing the output section 12a, the first output branch 12c, and the second output branch 12e respectively, and where e is the natural exponent, i is the imaginary unit, ω is an angular velocity, and t is a time variable.

The power output of the output section 12a can be calculated by the following equation:

S=α²=α₁²+α₂²+2α₁α₂ cos(φ-β),

wherein S is the power output of the output section 12a.

Similarly, the power outputs of the first and second output branches 12c, 12e can be calculated by the following equations:

α₁e^{i(φ-wt)}α₁₁e^{i(φ}^{₁}^{-wt)}+α₁₂e^{i(φ}^{₂}^{-wt)},

Q₁=α₁²=α₁₁²+α₁₂²+2α₁₁α₁₂ cos(φ₁-φ₂),

α₂e^{i(φ-wt)}α₂₁e^{i(β}^{₁}^{-wt)}+α₂₂e^{i(β}^{₂}^{-wt)},

Q₂=α₂²=α₂₁²+α₂₂²+2α₂₁α₂₂ cos(β₁-β₂),

wherein α₁₁, α₁₂, α₂₂, α₂₂ are amplitudes of lightwaves traversing the first to fourth secondary branches 124, 125, 127, 128 respectively, φ₂, β₁, β₂, are phases of lightwaves traversing the first to fourth secondary branches 124, 125, 127, 128 respectively, and Q₁, Q₂ are the respective outputs of the first and second secondary output section 12c, 12e.

α₁e^{i(φ-wt)}α₁₁e^{i(φ}^{₁}^{-wt)}+α₁₂e^{i(φ}^{₂}^{-wt)},

Q₁=α₁²=α₁₁²+α₁₂²+2α₁₁α₁₂ cos(φ₁-φ₂),

α₂e^{i(φ-wt)}α₂₁e^{i(β}^{₁}^{-wt)}+α₂₂e^{i(β}^{₂}^{-wt)},

Q₂=α₂²=α₂₁²+α₂₂²+2α₂₁α₂₂ cos(β₁-β₂),

The lightwaves have transverse electric waves (hereinafter the TE mode) and transverse magnetic waves (hereinafter the TM mode). In a coordinate system xyz (see FIG. 1), wherein x axis is a vertical height of the substrate 110 (i.e., perpendicular to the top surface 114), y axis is a horizontal width of the substrate 110 (parallel with the top surface 114 and perpendicular to the first to fourth branches 124, 125, 127, 128), and Z axis is a length of the substrate 110 (i.e., along a direction that is parallel with the first to fourth branches 124, 125, 127, 128), the TE mode has an electric field component \vec{Ey} vibrating along the Y axis only. The TM mode has an electric field component \vec{Ex} vibrating along the X axis and a \vec{Ez} vibrating along the Z axis.

By constructing the first to third recesses 111-113, the electrodes 131-137 as described above, modulating electric fields \vec{E}1, \vec{E}2, \vec{E}3, \vec{E}4 generated by the electrodes 131-137 traverse the first to fourth branches 124, 125, 127, 128, respectively. Portions of the electric field \vec{E}1, \vec{E}2 interacting with the first and second branches 124, 125 are substantially parallel with the x axis, and thus efficiently modulates the TM mode (i.e. \vec{Ex}) and alters the phase φ₁, φ₂. Similarly, portions of the electric field \vec{E}3, \vec{E}4 interacting with the fourth branch 128 is substantially parallel with the x axis, and thus efficiently modulates the TM mode (i.e. \vec{Ex}) and alters the phase β₁, β₂.

By changing the phases φ₁, φ₂, β₁, β₂, the following equations: Q₁=Q₂, and φ−β=0 (or φ−β=π) can be realized. As such, when the modulator 10 is used as a switch, the power output of the waveguide 120 is at zero in an off-state and substantially reaches a desired maximum value in an on state, and thus an extinction ratio of the modulator 10 is increased.

To avoid lightwaves being absorbed by the first ground electrode 132, the second modulating electrode 133, the third modulating electrode 135, and the third ground electrode 136, buffer layers 140 are formed and sandwiched between the substrate 110 and the first ground electrode 132, the second modulating electrode 133, the third modulating electrode 135, and the third ground electrode 136. The buffer layers 140 can be made of silicon dioxide.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electro-optic modulator, comprising:
a substrate;
a Y-shaped waveguide formed in the substrate and comprising a first Y-shaped section and a second Y-shaped section, the first Y-shaped section comprising a first branch and a second branch, the second Y-shaped section comprising a third branch and a fourth branch, the second and fourth branches being positioned at two opposite sides of the first and third branches; the substrate defining a first to third recesses, the first and third recesses being located at two opposite sides of the waveguide, the second recess being located between the first and second sections;
a first modulating electrode fully filling the first recess;
a first ground electrode positioned on the substrate and covering the second branch;
a second modulating electrode positioned on the substrate and covering the first branch;
a second ground electrode fully filling the second recess;
a third modulating electrode positioned on the substrate and covering the third branch;
a third ground electrode positioned on the substrate and covering the fourth branch; and
a fourth modulating electrode fully filling the third recess.

2. The modulator of claim 1, wherein the substrate is made of lithium niobate crystal.

3. The modulator of claim 1, wherein the waveguide is made of lithium niobate crystal diffused with titanium.

4. The modulator of claim 1, wherein the waveguide comprises an input section and an output section, and the first and second sections diverge from the input section and are converged into the output section.

5. The modulator of claim 1, wherein the first section comprises a first input branch and a first output branch, and the first and second branches diverge from the first input branch and are converged into the first output branch.

6. The modulator of claim 1, wherein the second section comprises a second input branch and a second output branch, and the third and fourth branches diverge from the second input branch and are converged into the second output branch.

7. The modulator of claim 1, wherein the first to fourth branches are parallel with each other.

8. The modulator of claim 7, wherein the first to third recess are rectangular and parallel with the first to fourth branches.

9. The modulator of claim 8, wherein the firs recess has the same length as and is aligned with the second branch.

10. The modulator of claim 8, wherein the third recess has the same length as and is aligned with the fourth branch.

11. The modulator of claim 8, wherein orthogonal projections of the first and third recesses on the second recess fall within the second recess.

12. The modulator of claim 7, wherein the first ground electrode, the second modulating electrode, the third modulating electrode, and the third ground electrode are strip-shaped and parallel with the first to fourth branches.

13. The modulator of claim 1, wherein the first ground electrode and the second modulating electrode have the same length as and are aligned with the second branch.

14. The modulator of claim 1, wherein the third modulating electrode and the third ground electrode have the same length as and are aligned with the fourth branch.

15. The modulator of claim 1, comprising a buffer layer formed and sandwiched between the substrate and the first ground electrode, the second modulating electrode, the third modulating electrode, and the third ground electrode.

16. The modulator of claim 15, wherein the buffer layer is made of silicon dioxide.
